(19) United States
(12) Patent Application Publication
(10) Pub. No.: US 2025/0307774 A1
(43) Pub. Date: Oct. 2, 2025

(54) DYNAMICALLY GENERATING TASK APPROVAL REQUESTS USING ARTIFICIAL INTELLIGENCE TECHNIQUES

(71) Applicant: Dell Products L.P., Round Rock, TX (US)

(72) Inventors: Vivek Bhargava, Bangalore (IN); Mayank Kapoor, Bangalore (IN); Furkan Mohd Nisar, Ambedkar Nagar (IN); Dinesh Koppada, Bengaluru (IN)

(21) Appl. No.: 18/616,524

(22) Filed: Mar. 26, 2024

(51) Int. Cl. G06Q 10/10; G06Q 10/0631

(52) U.S. Cl. CPC G06Q 10/103; G06Q 10/063112

(57) ABSTRACT

Methods, apparatus, and processor-readable storage media for dynamically generating task approval requests using artificial intelligence techniques are provided herein. An example computer-implemented method includes obtaining at least one task approval request generated in connection with at least one requesting user; identifying one or more users to receive the at least one task approval request by processing data associated with the at least one task approval request using one or more artificial intelligence techniques; automatically transmitting at least a portion of the at least one task approval request to at least one of the one or more identified users using one or more software applications executing on one or more devices associated with the at least one identified user; and performing one or more automated actions based on at least one response to the at least one task approval request from the at least one identified user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Task approval workflows are common across various enterprises and other organizations, and such workflows can require one or more types of approval chains or sequences. However, conventional approval workflow techniques typically involve limitations with respect to predefined lists of exclusive approvers for certain types of requests, often creating resource wastage and other inefficiencies related to time zone complexities and approver availability issues.

### SUMMARY

Illustrative embodiments of the disclosure provide techniques for dynamically generating task approval requests using artificial intelligence techniques.

An exemplary computer-implemented method includes obtaining at least one task approval request generated in connection with at least one requesting user, and identifying one or more users to receive the at least one task approval request by processing data associated with the at least one task approval request using one or more artificial intelligence techniques. The method also includes automatically transmitting at least a portion of the at least one task approval request to at least one of the one or more identified users using one or more software applications executing on one or more devices associated with the at least one of the one or more identified users. Further, the method additionally includes performing one or more automated actions based at least in part on at least one response to the at least one task approval request from the at least one of the one or more identified users.

Illustrative embodiments can provide significant advantages relative to conventional approval workflow techniques. For example, problems associated with resource wastage and other inefficiencies are overcome in one or more embodiments through dynamically identifying, using artificial intelligence techniques, appropriate users to receive particular task approval requests, and automatically transmitting such task approval requests to the identified users.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for dynamically generating task approval requests using artificial intelligence techniques in an illustrative embodiment.

FIG. 2 shows an example table containing data pertaining to multiple task approval requests in an illustrative embodiment.

FIG. 3 shows an example table containing data pertaining to multiple task approvers in an illustrative embodiment.

FIG. 4 shows an example table containing data pertaining to a task approver in an illustrative embodiment.

FIG. 5 shows an example table containing data pertaining to multiple task approvers in an illustrative embodiment.

FIG. 6 shows an example workflow in connection with an illustrative embodiment.

FIG. 7 shows example pseudocode for implementing at least a portion of a machine learning-based classifier in an illustrative embodiment.

FIG. 8 is a flow diagram of a process for dynamically generating task approval requests using artificial intelligence techniques in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

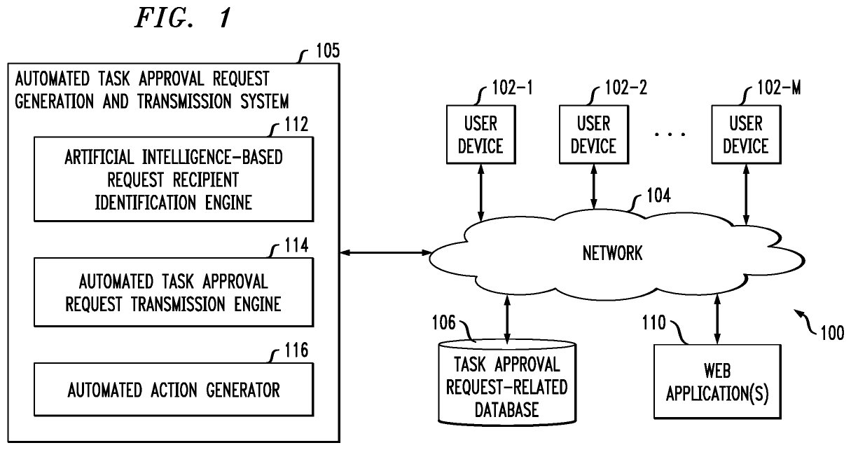

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated task approval request generation and transmission system 105 and one or more web applications 110 (e.g., integrated development environment (IDE) applications, local administrator rights-related (LAR-related) applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated task approval request generation and transmission system 105 can have an associated task approval request-related database 106 configured to store data pertaining to various task approval requests, various requestors, various request approvers, etc.

The task approval request-related database 106 in the present embodiment is implemented using one or more storage systems associated with the automated task approval request generation and transmission system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated task approval request generation and transmission system 105 are one or more input-output devices, which illustratively comprise keyboards, displays or other types of input-output devices in any combination. Such input-output devices can be used, for example, to support one or more user interfaces to the automated task approval request generation and transmission system 105, as well as to support communication between the automated task approval request generation and transmission system 105 and other related systems and devices not explicitly shown.

Additionally, the automated task approval request generation and transmission system 105 in the FIG. 1 embodiment is assumed to be implemented using at least one processing device. Each such processing device generally comprises at least one processor and an associated memory, and implements one or more functional modules for controlling certain features of the automated task approval request generation and transmission system 105.

More particularly, the automated task approval request generation and transmission system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated task approval request generation and transmission system 105 to communicate over the network 104 with the user devices 102, and illustratively comprises one or more conventional transceivers.

The automated task approval request generation and transmission system 105 further comprises artificial intelligence-based request recipient identification engine 112, automated task approval request transmission engine 114, and automated action generator 116.

It is to be appreciated that this particular arrangement of elements 112, 114 and 116 illustrated in the automated task approval request generation and transmission system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for dynamically generating task approval requests using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated task approval request generation and transmission system 105, task approval request-related database 106, and web application(s) 110 can be on and/or part of the same processing platform.

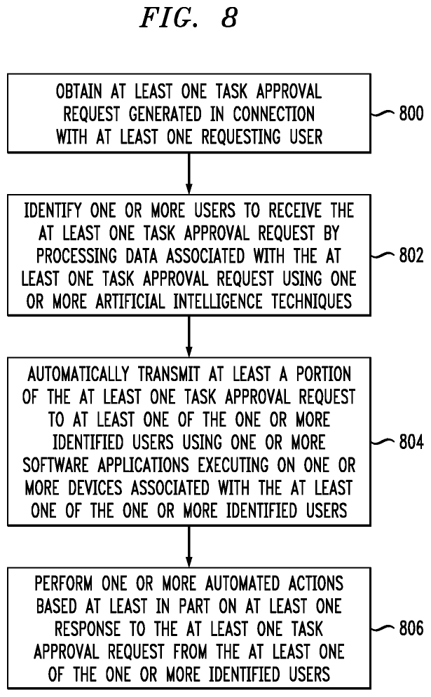

An exemplary process utilizing elements 112, 114 and 116 of an example automated task approval request generation and transmission system 105 in computer network 100 will be described in more detail with reference to the flow diagram of FIG. 8.

Accordingly, at least one embodiment includes dynamically generating task approval requests using artificial intelligence techniques. As further detailed herein, such an embodiment includes intelligently creating dynamic lists of approvers who are available, at that time to act upon corresponding requests, and transmitting such requests to at least a portion of such approvers.

One or more embodiments include creating and/or implementing at least one communication module for process workflows (e.g., task approval workflows) which can be used to identify and communicate with one or more approvers who are likely to respond to one or more workflow requests. Such an embodiment includes utilizing two-way, near real time communication involving a voting mechanism for secure and efficient decision on incidents, tickets, and/or other types of service management solutions and/or issues. As used herein, voting refers to a process wherein designated potential approvers offer their opinion or “vote” on a certain request (e.g., a certain incident, ticket, and/or service management solution). In one or more embodiments, a voting procedure enables and/or facilitates a collaborative and/or cooperative decision-making approach, as a request can be responded to based at least in part on the collective votes of potential approvers.

Accordingly, at least one embodiment includes enhancing message and/or notification delivery, as well as facilitating efficient resolutions in service management by identifying appropriate approvers for particular requests at appropriate times to render task approval workflows near real-time in nature.

By way merely of illustration, consider a scenario wherein a user sends out a task approval request from a given user device (e.g., via a device context menu). In such a scenario, at least one embodiment includes processing at least a portion of the task approval request and intelligently creating at least one dynamic list of potential approvers who are available at that time to act on the request. In identifying potential approvers, such an embodiment can include identifying individuals who are sufficiently likely to vote (i.e., act on the task approval request), based at least in part on historical data pertaining to acting on similar requests. One or more embodiments include selecting and/or tuning a threshold value for the decision and/or output of the artificial intelligence techniques (e.g., XGBoost model). By way of example, assume that the threshold value is set at 0.7, wherein the artificial intelligence techniques produce a probability score that falls between 0 and 1. In such an example embodiment, the artificial intelligence techniques predict that a potential approver is likely to respond to and/or approve a given request if their estimated probability is higher than 0.7, and predict that the potential approver is less inclined to respond to and/or approve if the estimated probability is below 0.7.

Additionally or alternatively, identifying such individuals can be based at least in part on the similarity of domain of work relative to the requestor, historical data pertaining to previous work with the requestor and/or other individuals associated with the user (e.g., past meetings, calls, discussions, chats, mails, etc.), and/or data pertaining to approver availability (e.g., data created by one or more systems being used by potential approvers at one or more times relevant to the request and evidencing approver availability or lack thereof). For example, such data pertaining to approver availability can indicate that a given potential approver is actively using (or not using) a relevant system and/or device, and/or can indicate that a given potential approver is actively engaged (or not) in one or more activities which require attention (e.g., on a call, etc.) and may preclude that individual from acting on the task approval request in a sufficiently timely manner. In one or more embodiments, identifying potential approvers can be carried out using a gradient boosting model such as, for example, an XGBoost model, which is trained using historical data, including metadata such as historical response patterns, domain alignment, and real-time system and/or device monitoring data. Such a model can then be used to predict the probability of each potential approver taking action on a new request.

After identifying one or more individuals to be potential approvers of the given task approval request, such an embodiment can include generating and transmitting at least one notification to at least a portion of the identified individuals. By way of example, transmitting such a notification can include identifying and utilizing at least one foreground application of a given potential approver's device for sending the at least one notification (e.g., using an email application running on the device, a telecommunications application running on the device, etc.). Additionally or alternatively, one or more embodiments can include determining one or more time frames within which the potential approver's probability of viewing and acting on the at least one notification is the highest, and transmitting the at least one notification during the one or more time frames. Such determinations with respect to foreground applications and potential approvers can be made, for example, by processing monitoring data related to usage patterns of given applications by the potential approvers.

In at least one embodiment, making such determinations includes creating at least one potential approver activity matrix and deriving probabilities for specific time windows. Such an embodiment can include collecting data pertaining to potential approver activity, including time spent and applications used over a given historical period, and creating a probability for each of multiple time windows (e.g., multiple five minute windows) in the potential approver's working time based at least in part on the activity matrix, considering free and busy periods. Additionally, such an embodiment can include determining one or more optimal times to send notifications to the given potential approver by leveraging the calculated probabilities and ensuring that the notification is likely to receive immediate attention.

Also, one or more embodiments can include facilitating efficient (e.g., near real-time) voting of responses to approve or reject given requests. By way merely of example, consider a scenario involving a request related to LAR, wherein the request seeks application-specific approval to grant LAR to install a specific application from the internet and correspondingly create a new technology and architectural global standards (TAGS) request for the application, wherein TAGS refers to a process related to establishing and maintaining global standards for technology and architecture within one or more organizations.

Accordingly, at least one embodiment can include building and/or implementing a classifier trained on relevant historical data (e.g., historical instances of similar LAR-related activity) to assist potential approvers in voting. More particularly, such an embodiment can include using such historical data and corresponding voting decisions (e.g., approvals or rejections of the requests) in connection with labeling data to train one or more machine learning models (e.g., one or more neural networks) to assist and recommend possible voting resolutions to potential approvers in the future. By way of example, such an embodiment can include using a recurrent neural network (RNN) with an attention mechanism, which works well with sequence data and is appropriate for tasks involving historical instances (e.g., such as text requests and voting decisions), to predict whether a potential approver is likely to approve or reject a request based at least in part on historical instances and contextual information. In such an embodiment, the RNN receives and/or processes a sequence of historical instances of approval requests, including details such as, e.g., the type of request, the requester's role, historical responses of the given potential approver, job level of the requestor and/or potential approval, job function of the requestor and/or potential approval, job title of the requestor and/or potential approval, application persona, etc. The RNN processes such historical data and contextual information and creates one or more hidden states for each step. Additionally, the attention mechanism assigns weights to different portions of the historical data and/or contextual information based at least in part on their relevance to the current request and/or prediction, and the decoder uses the attention-weighted context vectors to predict whether the current approval request is likely to be approved or rejected by one or more given potential approvers.

For example, at least one embodiment can include appending such labeled data with additional approver and/or requestor features such as, e.g., job level, job function, job title, etc., to increase the predictive quotient of the one or more machine learning models. Further, if the request is approved, one or more embodiments include automatically initiating at least one TAGS approval process and linking to raise a new request in the user's device.

As detailed above and herein, at least one embodiment includes determining and/or generating a dynamic list of potential approvers who are likely to act in near real-time to approve or reject task approval requests (e.g., user application installation requests). Such an embodiment can include processing historical data pertaining to users (e.g., potential approvers) acting on similar requests using one or more natural language processing (NLP) techniques, for example, to extract certain types of information from user-submitted text justifications for acting on requests. An example user-submitted text justification can include, e.g., a piece of text provided by a user to explain and/or justify a specific request. In the context of a request for approval, such text can serve as an explanation for why the user is making the particular request.

By way of example, named entity recognition techniques can be employed to identify and classify entities (e.g., user names, application names, etc.) within such text. Additionally or alternatively, sentiment analysis techniques can be utilized to discern one or more sentiments expressed in user justifications. Further, one or more embodiments can include incorporating and/or using one or more additional NLP techniques such as, for example, entity linking, one or more summarization techniques, and/or relationship extraction, to provide a sophisticated and contextually robust understanding of user-submitted text justifications.

By way merely of illustration, consider example user-submitted text including the following: “As a new hire, I need to work on PostgreSQL databases, and I request the installation of pgAdmin for streamlined database management. The current absence of a database tool hinders my productivity, and swift approval for the installation is important to perform my tasks effectively.” Using named entity recognition techniques, one or more embodiments can include identifying, from the above text, the following entities: User: [User's Name]; Application: pgAdmin; Purpose: Work on PostgreSQL databases. Additionally, sentiment analysis techniques can be used to determine that the sentiment associated with the above text is positive. Also, based on such NLP analysis, contextual information can be determined wherein the user expresses a need for pgAdmin to streamline database management tasks, indicating a positive and crucial requirement for the tool.

One or more embodiments can also include embedding at least a portion of a text justification to at least one vector representation using one or more pre-trained large language models (LLMs) such as, for example, at least one bidirectional encoder representations from transformers (BERT) model. In such an embodiment, the user-submitted text justification can be split into chunks and/or sentences, and each sentence and/or chunk is individually embedded using a pre-trained BERT model, which provides contextualized embeddings for each word in the sentence and/or chunk. The sets of numbers (i.e., the embeddings) from each sentence and/or chunk are then aggregated to create a unified representation of the user's justification, and the aggregated set of numbers captures the contextual understanding of the entire text.

Because such models can have limits on how much text can be processed at once, such an embodiment can include dividing such text into chunks, wherein each chunk is individually embedded to at least one vector representation, and each chunk is separately turned into at least one set of numbers. In such an embodiment, the set(s) of numbers from each chunk can be combined and/or aggregated to create one larger set of numbers that represents the entire user justification. Such a combined set of numbers can facilitate the LLM in learning and/or understanding the corresponding user's request in a more efficient manner.

By way merely of illustration, consider example user-submitted text including the following: “I want to install Database Management Tool X on my computer to connect to a structured query language (SQL) server database. Please approve my request.” At least one embodiment can include dividing this text into three chunks as follows:
Chunk 1: “I want to install Database Management Tool X on my computer.”
Chunk 2: “I want to connect to a SQL server database.”
Chunk 3: “Please approve my request.”

Additionally, such an embodiment can include generating numerical representations for each chunk as follows: Chunk 1: [0.4, 0.7, −0.2]; Chunk 2: [0.9, −0.1, 0.8]; Chunk 3: [0.6, 0.3, 0.7]. As detailed above, these sets of numbers, or numerical representations, can be generated through the process of text embedding using, e.g., a pre-trained BERT model. Further, as also noted above, at least portions of these sets of numbers can then be combined to create a combined set as follows: [(0.4+0.9+0.6)/3, (0.7−0.1+0.3)/3, (−0.2+0.8+0.7)/3], which results in a combined set of [0.633, 0.3, 0.433]. In such an embodiment, the combined set of [0.633, 0.3, 0.433] represents the user's overall request.

At least one embodiment also includes associating at least one given text justification with previously submitted approved and unapproved justifications using one or more similarity measures such as, for example, cosine similarity. Such an embodiment can include identifying, across the justifications, one or more patterns, one or more similarities, and/or relevant contextual information. Further, in such an embodiment, cosine similarity measures the cosine of the angle between two vectors (generated such as detailed above, for example) and provides a value between −1 and 1, wherein 1 indicates a high degree of similarity and −1 indicates dissimilarity between the text justifications.

By way merely of illustration, consider the following two example text justifications: (1) “I am requesting approval to install pgAdmin for database administration;” and (2) “I need permission for pgAdmin installation to manage databases efficiently.” Assume, for purposes of this illustration, that these texts are embedded into vectors, wherein the embedding for Sentence1 (S1) is [0.2, 0.8, −0.3, . . . ], and the embedding for Sentence2 (S2) is [0.1, 0.7, −0.4, . . . ]. Additionally, the cosine of two non-zero vectors can be derived using, for example, the Euclidean dot product formula as follows:

$$A \cdot B = ‖ A ‖ ‖ B ‖ cos θ$$

Given two n-dimensional vectors of attributes, A and B, the cosine similarity, cos θ, can be represented using a dot product and magnitude as follows:

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i - 1}^{n} {A}_{i}^{2} {\sum }_{i - 1}^{n} {B}_{i}^{2}}} ,$$

wherein Aᵢ and Bᵢ are the i^{th} components of vectors A and B, respectively.

Assume further, for the purposes of this illustration, that the calculation results in a cosine similarity score of 0.85. A cosine similarity score of 0.85 suggests a high degree of similarity between the two justifications, which indicates that the corresponding requests are closely related in terms of their language and/or context, specifically regarding the installation of pgAdmin for database administration.

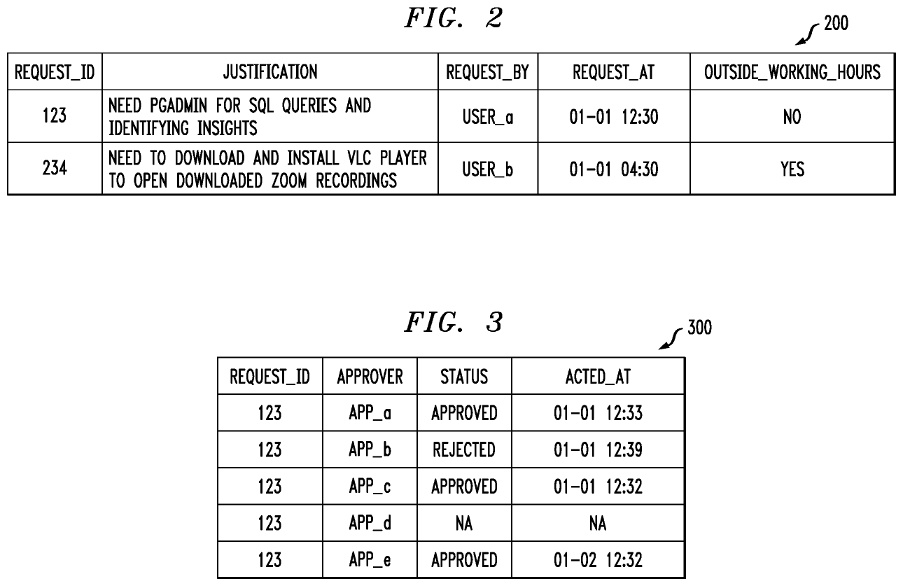

FIG. 2 shows an example table containing data pertaining to multiple task approval requests in an illustrative embodiment. By way of illustration, FIG. 2 depicts example table 200 which includes columns detailing request identifiers (IDs), request justifications, requestor information, request timestamp, and indication of request submitted outside of working hours or not.

FIG. 3 shows an example table containing data pertaining to multiple task approvers in an illustrative embodiment. By way of illustration, FIG. 3 depicts example table 300 which includes columns detailing request IDs, approver information, approval status, and approval timestamp.

As detailed herein, table 200 and table 300 are examples of datasets which can be used for training at least one machine learning-based classifier model.

As noted above and herein, one or more embodiments include identifying potential approvers based at least in part on similarities of work domain with respect to the requestor. Such an embodiment can include using one or more of user-installed software and user metadata to identify people in a similar work and/or task-related domain as the requestor. Attributes such as, for example, job level, job function, job title, etc., as well as identifying information related to the applications installed on each corresponding device can be utilized to cluster similar people operating within one or more similar domains. One or more clustering algorithms such as, for example, hierarchical density-based spatial clustering of applications with noise (HDBSCAN), can be used to process such data and generate clusters and/or segments of users, wherein such clusters and/or segments are of varying sizes and/or shapes. In an example embodiment, the shape of the clusters and/or segments can illustrate the diversity and/or complexity of the relationships among users in the same domain of work.

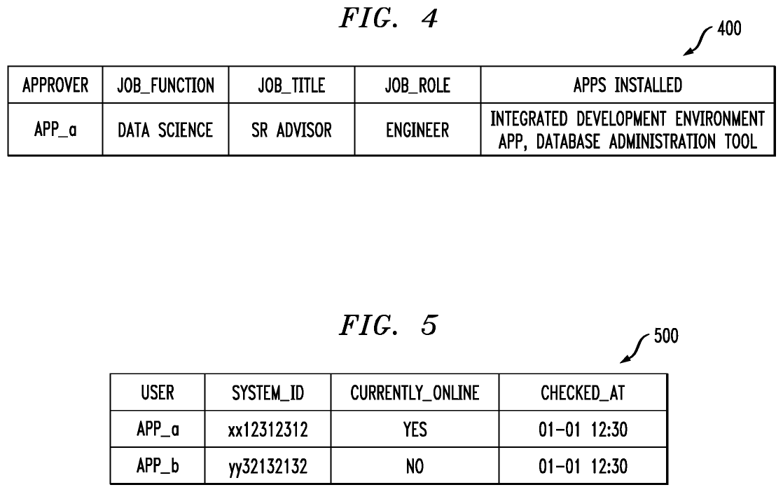

FIG. 4 shows an example table containing data pertaining to a task approver in an illustrative embodiment. By way of illustration, FIG. 4 depicts example table 400 which includes columns detailing approver information, approver job function, approver job title, approver job role, and applications installed by the approver. Additionally, in one or more embodiments, example table 400 can be used to train at least one machine learning-based classifier model.

As also detailed herein, one or more embodiments include identifying potential approvers based at least in part on historical data pertaining to potential approvers interacting and/or function with the requestor and/or a one or more users associated with the requestor (e.g., the requestor's team). Such historical data can include, for example, data pertaining to previous meetings, calls, discussions, chats, emails, etc.

Additionally or alternatively, at least one embodiment can include identifying potential approvers based at least in part on system data and/or monitoring data pertaining to systems and/or devices associated with potential approvers. Such system data and/or monitoring data can include, for example, meeting history data (e.g., meeting timestamps, meeting durations, identifying information of participants in meetings involving potential approvers and the requestor and/or the requestor's team, etc.), call logs pertaining to calls between potential approvers and the requestor and/or the requestor's team, email communication data, chat and/or instant messaging logs for conversations and/or interactions between potential approvers and the requestor and/or the requestor's team, device usage metrics pertaining to potential approvers' devices, application usage pattern data for applications used by potential approvers, etc. Analysis of such data can inform the identification of potential approvers who are likely to be responsive and/or collaborative based on past interactions and/or device and system usage.

Further, in connection with such an embodiment, such data can be processed and/or utilized to determine whether at least one given potential approver is currently engaged and/or soon-to-be engaged in an activity (e.g., on a call, writing emails, etc.) which requires attention such that the given potential approver would be less likely to act on a task approval request in a sufficiently timely manner.

FIG. 5 shows an example table containing data pertaining to multiple task approvers in an illustrative embodiment. By way of illustration, FIG. 5 depicts example table 500 which includes columns detailing approver information, approver system ID, current online status, and check-in timestamp. Additionally, in one or more embodiments, example table 500 can be used to train at least one machine learning-based classifier model.

At least one embodiment includes training one or more artificial intelligence techniques such as, for example, at least one machine learning-based classifier model under a gradient boosting framework (e.g., XGBoost, utilizing one or more decision trees as building blocks for creating weak classifiers) to calculate the probability of a potential approver acting on a task approval request. Such training can be carried out utilizing data pertaining to the given potential approver including, e.g., potential approver details, the potential approver's past acting history, the potential approver's system and/or device usage data, etc. Based on the results of the model processing, at least one embodiment can include ranking potential approvers based on their probability of acting on the given request, and one or more notifications pertaining to the given request can be automatically generated and transmitted to at least a portion of the ranked potential approvers (e.g., to the top-n potential approver(s)).

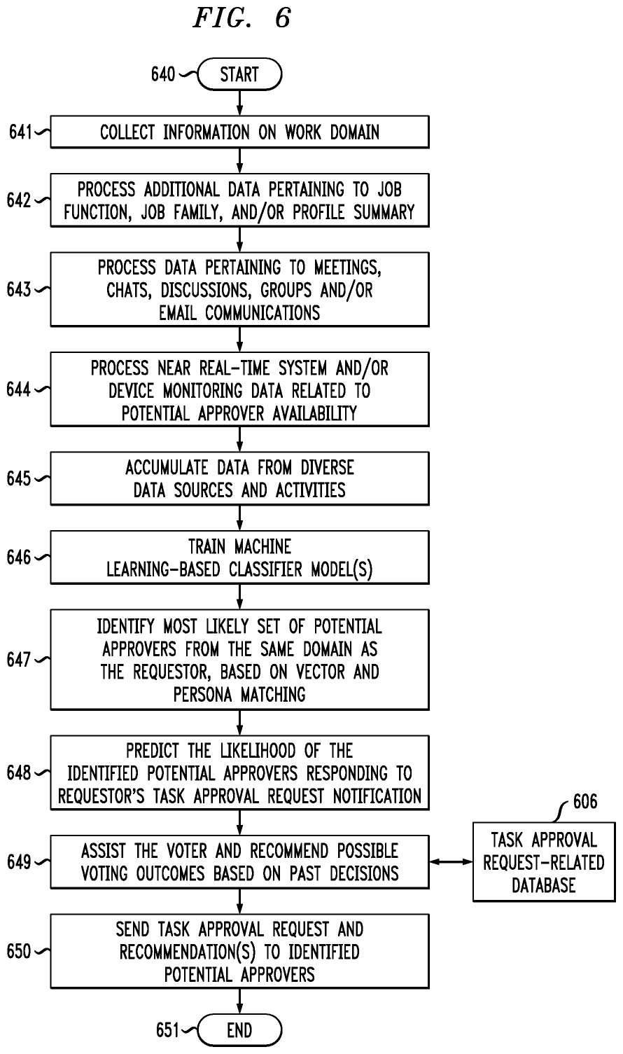

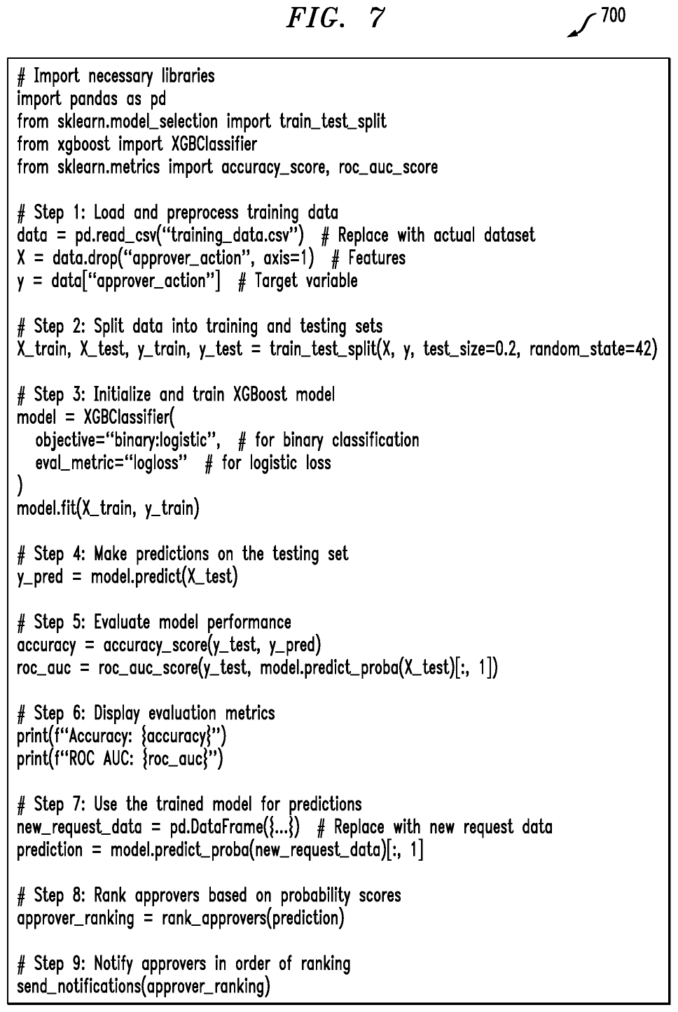

FIG. 6 shows an example workflow in connection with an illustrative embodiment. By way of illustration, the workflow starts at step 640, and step 641 includes collecting information pertaining to the work domain of the requestor and/or one or more potential approvers. Step 642 includes processing additional data pertaining to job function, job family, profile summary, etc., of the requestor and/or one or more potential reviewers, and step 643 includes processing data pertaining to meetings, chats, discussions, groups, and/or email communications related to the requestor and/or one or more potential reviewers. Also, step 644 includes processing near real-time system and/or device monitoring data related to potential approver availability for responding to a task approval request.

Step 645 includes accumulating data from diverse data sources and activities related to the requestor and/or one or more potential reviewers, and step 646 includes using at least a portion of such data to train one or more machine learning-based classifier models. Additionally, step 647 includes using the one or more machine learning-based classifier models to identify the most likely set of potential approvers form the same domain as the requestor, based at least in part on vector representations and persona matching techniques. Step 648 then includes using the one or more machine learning-based classifier models to predict the likelihood of the identified set of potential approvers responding to the requestor's task approval request notification.

As also depicted in FIG. 6, step 649 includes using data (e.g., historical request data and historical voting decision data) from task approval request-related database 606 to assist the potential approver(s) and generate at least one recommendation pertaining to voting outcomes. In step 650, the notification, including the task approval request and the at least one recommendation, is sent to at least a portion of the identified set of potential approvers, and in step 651, the workflow ends.

In one or more embodiments, the data used in training the one or more artificial intelligence techniques (e.g., at least one machine learning-based classifier) can encompass various dimensions including, for example, potential approver-specific features such as historical response patterns, domain alignment, real-time system data and/or monitoring data reflecting the potential approver's current activities, etc. Additionally, such training data can include user-centric data (i.e., data pertaining to the user submitting the task approval request and/or data pertaining to the potential approval) such as, e.g., job level, job function, job title, application persona, etc. As used herein, a persona refers to a profile and/or representation of a particular user's behavior and interactions, particularly with respect to one or more software programs. As detailed herein, such a persona can contribute to the identification of potential approvers who are in the same domain of work as a given requestor.

In at least one embodiment, at least a portion of such training data can be compiled into a training dataset, which can then be split into training and testing data subsets to enhance robustness of the model. Also, at least a portion of the testing data subset can be evaluated to validate the model's performance and ability to generalize to new and/or unseen data.

Upon completion of the training process, the one or more artificial intelligence techniques (e.g., at least one XGBoost model) generate a probability score for one or more potential approvers, indicating the likelihood of the potential approver acting on a given task approval request. At least a portion of the one or more potential approvers can then be ranked based at least in part on the generated probabilities, allowing for the prioritized notification of individuals who are most likely to respond promptly and effectively to the given task approval request.

By way merely of illustration, consider an example use case wherein a given enterprise employee (User1) needs to install a SQL server management application to connect to a database for a project. User1 raises a request for the installation through the enterprise's approval system. In accordance with one or more embodiments, at least one XGBoost model can be used to predict the probability of one or more potential approvers, within the enterprise, acting on the request.

In such an example use case, training data for the at least one XGBoost model can include, e.g., historical instances of similar requests, encompassing features such as the type of software being requested, the employee's role within the enterprise, the project details, the past behavior and/or patterns of the potential approvers, etc. The output of the at least one XGBoost model can include the following: Potential Approver1 responds frequently to similar requests (highest rank); Potential Approver2 is known for slow responses and is less likely to act (lower rank); and Potential Approver3 typically handles requests related to software development, but the request is more relevant to database administration (lowest rank).

By way of further illustration, consider an example use case wherein User1 submits a request to install a software application through an enterprise's approval system. Upon receiving and/or processing the request, one or more embodiments includes initiating the process of identifying potential approvers for the request based at least in part on historical data, application personas, and one or more other relevant factors. Based on such analysis, at least one embodiment includes identifying Potential Approver1, who is known for their responsiveness, domain alignment, and historical collaboration with User1's team. Such an embodiment also includes then automatically transmitting an instantaneous notification to Approver1 using at least one API, whereby Approver1 receives the notification and views the request details. Additionally, as part of the notification, one or more embodiments can include generating and providing, using at least one machine learning-based classifier model, at least one suggestion on whether to approve or reject the request based at least in part on one or more historical patterns and contextual information. Approver1's approval or rejection of the request can then be processed and registered, and based thereon, one or more embodiments can include initiating one or more automated actions (e.g., automatically initiating the approval process for the software installation in response to approval of the request).

At least one embodiment also includes determining when to send notifications (e.g., notifications seeking action on at least one given task approval request) to one or more potential approvers. Such a determination can be based at least in part on previous application and/or device usage patterns of the one or more potential approvers, which can facilitate identifying one or more ideal and/or appropriate windows of time in which to send the notifications, thereby enhancing the probability of response for the requester in near real time. One or more embodiments can include, for example, creating at least one approver activity matrix of time spent and applications used for a given period of time (e.g., the past 30 days). Using the matrix, such an embodiment can include determining a probability of acting on a request for each of multiple temporal periods (e.g., each window of five minutes in the potential approver's working time, depending upon the free and busy minutes in the potential approver's average daily time mapping).

With respect to the transmission of the notifications to one or more potential approvers, at least one embodiment can include using one or more particular application programming interfaces (APIs) to send instant and/or sticky notifications in connection with desktop and/or mobile devices.

As detailed herein, one or more embodiments include intelligently classifying if one or more potential approvers are likely to respond to a given task approval request, and identifying one or more time frames for transmitting at least one notification to at least a portion of the classified potential approvers wherein the probability of responding in a near real time manner is enhanced.

At least one embodiment can also include using at least one NLP model to determine the severity level of task approval requests based at least in part on the emotions and urgency-related language used in connection with the requests. Such determinations can be carried out, for example, through training at least one NLP model to predict the emotions on domain-specific training data including previous requestor and/or approver justifications. In one or more embodiments, a vector representation can be generated of the given task approval request, one or more voting details (e.g., information related to the decision-making process of potential approvers when responding to task approval requests, such as vote type, timestamp(s), user identifying information, historical voting pattern information, etc.) and one or more approver-requester details (e.g., job function, job title, etc.). Additionally, in such an embodiment, the vector representation can be used in connection with at least one similarity analysis (e.g., to measure semantic similarity between different user justifications), at least one clustering algorithm (e.g., to group similar user justifications together based on their vector representations), at least one sentiment analysis, one or more pattern recognition techniques (e.g., to identify patterns and/or trends in user justifications), and/or training one or more machine learning models.

In such an embodiment, notifications can be generated and transmitted, based at least in part on the level of urgency attributed to the requestor and/or the request, to at least one potential approver determined to have the time and ability to respond promptly to the request.

FIG. 7 shows example pseudocode for implementing at least a portion of a machine learning-based classifier in an illustrative embodiment. In this embodiment, example pseudocode 700 is executed by or under the control of at least one processing system and/or device. For example, the example pseudocode 700 may be viewed as comprising a portion of a software implementation of at least part of automated task approval request generation and transmission system 105 of the FIG. 1 embodiment.

The example pseudocode 700 illustrates steps to build, train, and use an XGBoost model to predict potential approver actions and prioritize notifications based at least in part on the likelihood of action and/or approval. More particularly, example pseudocode 700 details steps of importing necessary libraries, loading and preprocessing training data, splitting data into training and testing sets, and initializing and training the XGBoost model. Additionally, example pseudocode 700 details steps of generating one or more predictions on the testing dataset, evaluating model performance, displaying one or more evaluation metrics, using the trained model for generating one or more predictions, ranking potential approvers based on probability scores, and notifying potential approvers in order of ranking.

It is to be appreciated that this particular example pseudocode shows just one example implementation of at least a portion of a machine learning-based classifier, and alternative implementations can be used in other embodiments.

FIG. 8 is a flow diagram of a process for dynamically generating task approval requests using artificial intelligence techniques in an illustrative embodiment. It is to be understood that this particular process is only an example, and additional or alternative processes can be carried out in other embodiments.

In this embodiment, the process includes steps 800 through 806. These steps are assumed to be performed by the automated task approval request generation and transmission system 105 utilizing elements 112, 114 and 116.

Step 800 includes obtaining at least one task approval request generated in connection with at least one requesting user. Step 802 includes identifying one or more users to receive the at least one task approval request by processing data associated with the at least one task approval request using one or more artificial intelligence techniques. In at least one embodiment, identifying one or more users to receive the at least one task approval request includes calculating a probability, for each of the one or more users, of acting on the at least one task approval request within a given time frame by processing data associated with the at least one task approval request using at least one machine learning-based gradient boosting classifier model. Such an embodiment can also include training the at least one machine learning-based gradient boosting classifier model using labeled data derived from historical records of previous task approval requests and responses corresponding thereto.

Additionally or alternatively, identifying one or more users to receive the at least one task approval request can include determining one or more users, from at least one set of multiple users, that are one or more of the following: (i) available to act on the at least one task approval request, (ii) associated with at least a given level of likeliness to act on the at least one task approval request, and (iii) associated with at least one domain sharing at least a given level of similarity with a domain associated with the at least one requesting user. Such an embodiment can also include training the one or more artificial intelligence techniques by processing historical data pertaining to at least a portion of the at least one set of multiple users acting on one or more task approval requests associated with at least a given level of similarity to the at least one task approval request using one or more NLP techniques. Also, in such an embodiment, processing historical data can include processing historical data pertaining to at least a portion of the at least one set of multiple users acting on one or more task approval requests associated with at least a given level of similarity to the at least one task approval request using one or more entity recognition techniques to identify and classify one or more entities within the historical data pertaining to the one or more task approval requests. Additionally or alternatively, processing historical data can include processing historical data pertaining to at least a portion of the at least one set of multiple users acting on one or more task approval requests associated with at least a given level of similarity to the at least one task approval request using one or more sentiment analysis techniques to determine one or more sentiments expressed in one or more of the one or more task approval requests and one or more responses to the one or more task approval requests.

Further, in at least one embodiment, identifying one or more users to receive the at least one task approval request includes processing data pertaining to the at least one requesting user comprising one or more of requesting user job level information, requesting user job function information, requesting user job title information, and resource information associated with the at least one task approval request.

Step 804 includes automatically transmitting at least a portion of the at least one task approval request to at least one of the one or more identified users using one or more software applications executing on one or more devices associated with the at least one of the one or more identified users. In one or more embodiments, automatically transmitting at least a portion of the at least one task approval request to at least one of the one or more identified users includes determining an active presence of the one or more software applications executing in a foreground of the one or more devices associated with the at least one of the one or more identified users based at least in part on device monitoring data.

Step 806 includes performing one or more automated actions based at least in part on at least one response to the at least one task approval request from the at least one of the one or more identified users. In at least one embodiment, performing one or more automated actions includes automatically initiating, upon obtaining an approval from the at least one of the one or more identified users, the at least one task associated with the at least one task approval request. Also, in one or more embodiments, performing one or more automated actions includes automatically notifying the at least one requesting user, via at least one device associated with the at least one requesting user, that the at least one task approval request has been one of approved by the at least one of the one or more identified users and rejected by the at least one of the one or more identified users. Additionally or alternatively, performing one or more automated actions can include automatically training at least a portion of the one or more artificial intelligence techniques using the at least one response to the at least one task approval request from the at least one of the one or more identified users.

Further, the techniques depicted in FIG. 8 can also include generating, using the one or more artificial intelligence techniques in connection with at least one of one or more historical patterns related to the at least one task approval request and contextual information related to the at least one task approval request, at least one suggestion regarding responding to the at least one task approval request. Such an embodiment can additionally include incorporating the at least one suggestion into the at least one task approval request prior to automatically transmitting the at least a portion of the at least one task approval request to the at least one of the one or more identified users.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to dynamically identify, using artificial intelligence techniques, appropriate users to receive particular task approval requests, and automatically transmit such task approval requests to the identified users. These and other embodiments can effectively overcome problems associated with resource wastage and other inefficiencies.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

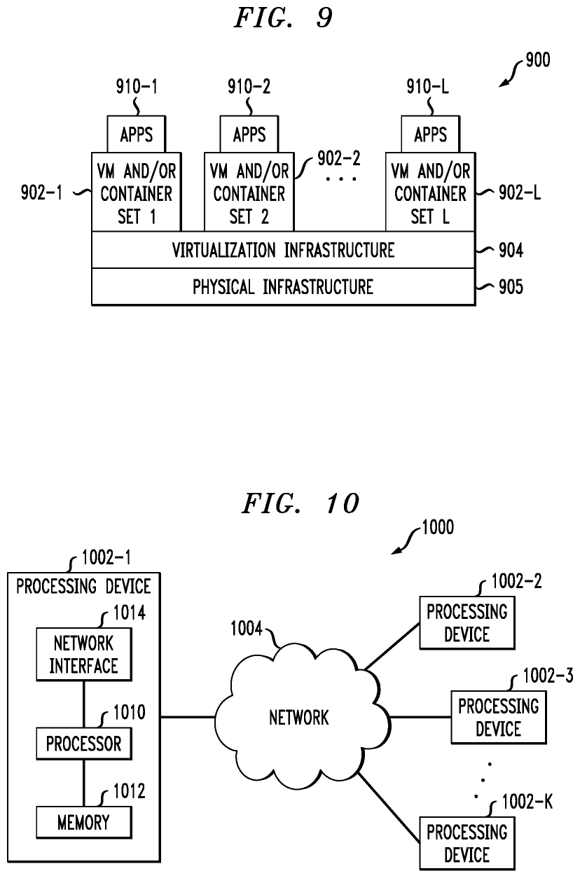

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more information processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a CPU, a GPU, a TPU, a microcontroller, an ASIC, a FPGA or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one task approval request generated in connection with at least one requesting user;
identifying one or more users to receive the at least one task approval request by processing data associated with the at least one task approval request using one or more artificial intelligence techniques;
automatically transmitting at least a portion of the at least one task approval request to at least one of the one or more identified users using one or more software applications executing on one or more devices associated with the at least one of the one or more identified users; and
performing one or more automated actions based at least in part on at least one response to the at least one task approval request from the at least one of the one or more identified users;
wherein the method is performed by at least one processing device comprising a processor coupled to a memory.

2. The computer-implemented method of claim 1, wherein identifying one or more users to receive the at least one task approval request comprises calculating a probability, for each of the one or more users, of acting on the at least one task approval request within a given time frame by processing data associated with the at least one task approval request using at least one machine learning-based gradient boosting classifier model.

3. The computer-implemented method of claim 2, further comprising:
training the at least one machine learning-based gradient boosting classifier model using labeled data derived from historical records of previous task approval requests and responses corresponding thereto.

4. The computer-implemented method of claim 1, wherein performing one or more automated actions comprises automatically initiating, upon obtaining an approval from the at least one of the one or more identified users, at least one task associated with the at least one task approval request.

5. The computer-implemented method of claim 1, wherein performing one or more automated actions comprises automatically training at least a portion of the one or more artificial intelligence techniques using the at least one response to the at least one task approval request from the at least one of the one or more identified users.

6. The computer-implemented method of claim 1, further comprising:
generating, using the one or more artificial intelligence techniques in connection with at least one of one or more historical patterns related to the at least one task approval request and contextual information related to the at least one task approval request, at least one suggestion regarding responding to the at least one task approval request; and
incorporating the at least one suggestion into the at least one task approval request prior to automatically transmitting the at least a portion of the at least one task approval request to the at least one of the one or more identified users.

7. The computer-implemented method of claim 1, wherein identifying one or more users to receive the at least one task approval request comprises determining one or more users, from at least one set of multiple users, that are one or more of the following: (i) available to act on the at least one task approval request, (ii) associated with at least a given level of likeliness to act on the at least one task approval request, and (iii) associated with at least one domain sharing at least a given level of similarity with a domain associated with the at least one requesting user.

8. The computer-implemented method of claim 7, further comprising:
training the one or more artificial intelligence techniques by processing historical data pertaining to at least a portion of the at least one set of multiple users acting on one or more task approval requests associated with at least a given level of similarity to the at least one task approval request using one or more natural language processing (NLP) techniques.

9. The computer-implemented method of claim 8, wherein processing historical data comprises processing historical data pertaining to at least a portion of the at least one set of multiple users acting on one or more task approval requests associated with at least a given level of similarity to the at least one task approval request using one or more entity recognition techniques to identify and classify one or more entities within the historical data pertaining to the one or more task approval requests.

10. The computer-implemented method of claim 8, wherein processing historical data comprises processing historical data pertaining to at least a portion of the at least one set of multiple users acting on one or more task approval requests associated with at least a given level of similarity to the at least one task approval request using one or more sentiment analysis techniques to determine one or more sentiments expressed in one or more of the one or more task approval requests and one or more responses to the one or more task approval requests.

11. The computer-implemented method of claim 1, wherein identifying one or more users to receive the at least one task approval request comprises processing data pertaining to the at least one requesting user comprising one or more of requesting user job level information, requesting user job function information, requesting user job title information, and resource information associated with the at least one task approval request.

12. The computer-implemented method of claim 1, wherein automatically transmitting at least a portion of the at least one task approval request to at least one of the one or more identified users comprises determining an active presence of the one or more software applications executing in a foreground of the one or more devices associated with the at least one of the one or more identified users based at least in part on device monitoring data.

13. The computer-implemented method of claim 1, wherein performing one or more automated actions comprises automatically notifying the at least one requesting user, via at least one device associated with the at least one requesting user, that the at least one task approval request has been one of approved by the at least one of the one or more identified users and rejected by the at least one of the one or more identified users.

14. A non-transitory processor-readable storage medium having stored therein program code of one or more software programs, wherein the program code when executed by at least one processing device causes the at least one processing device:
to obtain at least one task approval request generated in connection with at least one requesting user;
to identify one or more users to receive the at least one task approval request by processing data associated with the at least one task approval request using one or more artificial intelligence techniques;
to automatically transmit at least a portion of the at least one task approval request to at least one of the one or more identified users using one or more software applications executing on one or more devices associated with the at least one of the one or more identified users; and
to perform one or more automated actions based at least in part on at least one response to the at least one task approval request from the at least one of the one or more identified users.

15. The non-transitory processor-readable storage medium of claim 14, wherein identifying one or more users to receive the at least one task approval request comprises calculating a probability, for each of the one or more users, of acting on the at least one task approval request within a given time frame by processing data associated with the at least one task approval request using at least one machine learning-based gradient boosting classifier model.

16. The non-transitory processor-readable storage medium of claim 14, wherein performing one or more automated actions comprises automatically initiating, upon obtaining an approval from the at least one of the one or more identified users, at least one task associated with the at least one task approval request.

17. The non-transitory processor-readable storage medium of claim 14, wherein identifying one or more users to receive the at least one task approval request comprises determining one or more users, from at least one set of multiple users, that are one or more of the following: (i) available to act on the at least one task approval request, (ii) associated with at least a given level of likeliness to act on the at least one task approval request, and (iii) associated with at least one domain sharing at least a given level of similarity with a domain associated with the at least one requesting user.

18. An apparatus comprising:
at least one processing device comprising a processor coupled to a memory;
the at least one processing device being configured:
to obtain at least one task approval request generated in connection with at least one requesting user;
to identify one or more users to receive the at least one task approval request by processing data associated with the at least one task approval request using one or more artificial intelligence techniques;
to automatically transmit at least a portion of the at least one task approval request to at least one of the one or more identified users using one or more software applications executing on one or more devices associated with the at least one of the one or more identified users; and
to perform one or more automated actions based at least in part on at least one response to the at least one task approval request from the at least one of the one or more identified users.

19. The apparatus of claim 18, wherein identifying one or more users to receive the at least one task approval request comprises calculating a probability, for each of the one or more users, of acting on the at least one task approval request within a given time frame by processing data associated with the at least one task approval request using at least one machine learning-based gradient boosting classifier model.

20. The apparatus of claim 18, wherein performing one or more automated actions comprises automatically initiating, upon obtaining an approval from the at least one of the one or more identified users, at least one task associated with the at least one task approval request.
